(19) United States
(12) Patent Application Publication
(10) Pub. No.: US 2015/0196822 A1
(43) Pub. Date: Jul. 16, 2015

(54) PRECISION GOLF COURSE MAP

(71) Applicants: Osmo Voutilainen, Oulu (FI); Hannu Kallio-Kokko, Oulu (FI); Tuomo Lalli, Oulu (FI); Tarmo Elfving, Oulu (FI)

(72) Inventors: Osmo Voutilainen, Oulu (FI); Hannu Kallio-Kokko, Oulu (FI); Tuomo Lalli, Oulu (FI); Tarmo Elfving, Oulu (FI)

(73) Assignee: CaddieON Inc., Oulu (FI)

(21) Appl. No.: 14/572,840

(22) Filed: Dec. 17, 2014

Related U.S. Application Data
(60) Provisional application No. 61/917,946, filed on Dec. 19, 2013.

(51) Int. Cl. A63B 69/36; G01B 21/16; G01P 15/00

(52) U.S. Cl. CPC A63B 69/3608; G01P 15/00; G01B 21/16; A63B 2220/13

(57) ABSTRACT

The objects on golf course are mapped accurately enabling advantageous features in the automatic golf tracking system. Strokes can be recorded reliably into the right hole with automatic hole change algorithm observing golfer's presence in green and tee box objects. A method for improving automatic stroke recognition accuracy may include a procedure for configuring the stroke recognition algorithm dynamically based on golfer's position on mapped hole and distance to objects. In addition remaining false stroke recognitions may be removed with configurable post-filters.

### CROSS-REFERENCE TO RELATED APPLICATIONS

This application claims the benefit of U.S. Provisional Application No. 61/917,946 filed on Dec. 19, 2013.

### FIELD OF THE INVENTION

The present invention relates to the game of golf, and more particularly to mapping of golf courses in detail which can be utilized advantageously in automatic golf tracking systems.

### BACKGROUND OF THE INVENTION

Golf assistants, caddies, enable professional players to focus on their game. Caddies can take care of various game related tasks during the round. The caddie may carry the bag, suggest club selection based on player records, keep track on strokes and assist in reading putting lines. Most of the ordinary golf players cannot afford to use temporary caddie services and if they do, at least the key benefit of long-term partnership is missed: knowing the player's skills well enough.

Modern technology may be utilized to overcome the obstacles and indeed there have been some attempts to do so. There are number of automatic golf tracking and scoring devices available in the market, but an extra device may just disturb the player if it does not work well. The player pays too much attention to the device itself instead of his game, information offered during the round may be inadequate or inaccurate and longer term history data does not really support developing skills and achieving better results.

Precise course map data can greatly improve the golfing experience with automatic golf tracking devices. Different objects on golf course can be described as polygons overlaid on top of course map. There are number of important features that can gain benefit from such objects. As an example reliable change of hole during the round: Strokes and other game events are recorded with correct data and order to right hole which saves time needed for manual editing afterwards. Hole specific data shown to the golfer correspond to the hole to be played.

The key feature in electronic golf devices and applications is an electronic scorecard. Course map data can be utilized in score tracking as well. Score card is usually filled in manually, but some ideas for semi-automatic or fully automatic score tracking are presented. Semi-automatic solutions may e.g. rely on reading of special club ID tag but players often forget to read the tag with the reader so automatic score keeping is preferred. However, there are challenges like wide variation between strokes taken (drive, putt, chip etc.), different styles among players and many disturbing events during the round of golf. In addition, game situation, golfer's position on hole and location where the ball is played can affect the stroke characteristics. It is evident that a sophisticated personal golf stroke recognition algorithm is needed and it must be dynamically configurable to personal stroke characteristics during the round of golf in order to achieve high recognition accuracy.

Precise course mapping enables other advanced features, too, like more detailed game statistics for finding personal development areas, smart location based stroke filtering and club tag reading reminder to mention few.

These particular issues are addressed by the system and method presented in this application.

### BRIEF SUMMARY OF THE INVENTION

The object of the present invention is to improve reliability and accuracy of a golf tracking system including a golf stroke detection device and a computer program utilized in the golf stroke recognition system.

The object of the present invention is fulfilled by providing the method for updating hole automatically in a golf tracking system comprising:
observing change of surface location of golfer based on position and course map data; and
updating hole to the hole of the most recent surface location;
   and the method for improving accuracy of an automatic golf stroke recognition algorithm comprising:
configuring parameters of recognition algorithm based on position and course map data;
detecting set of stroke candidates from recorded sensor data with a configurable stroke recognition algorithm; and
rejecting false stroke recognitions from said set of stroke candidates with configurable post-filtering algorithm.

The objects of present invention can be fulfilled by an exemplary golf tracking system comprising:
a detection device configured to be attached to a golf player's forearm, the stroke detection device comprising:
   a battery;
   a power/energy management circuit;
   a tag reader;
   a motion sensor;
   a processor unit comprising a memory unit including a computer program;
   the memory unit and the computer program configured to, with the processor unit, cause the stroke detection device at least to process motion sensor data and;
   a wireless transceiver; and
a mobile device comprising:
   computer program to process motion data received from the detection device;
   computer program at least to track, analyse and update status of golf game;
   computer program to configure golf tracking system based on course map data;
   a positioning system to record golfer's location data;
   a wireless transceiver to exchange data with the detection device and a backend system; and
a backend system comprising computer program at least to store and exchange game data and golf course map data with the mobile device.

The objects of present invention can also be fulfilled by an exemplary golf tracking system wherein the backend system above is omitted and relevant tasks handled by the mobile device only.

The objects of present invention can also be fulfilled by an exemplary golf tracking system wherein the wrist device handless all relevant tasks above.

Some advantageous embodiments of the invention are disclosed in the dependent claims.

Further scope of applicability of the present invention will become apparent from the detailed description given hereafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and accompanying drawings which are given by way of illustration only, and thus are not limitative of the present invention and wherein

FIG. 1 shows an exemplary representation of an electronic caddie arrangement where the golf stroke detection device is utilized;

FIG. 2 shows an example where a golfer identifies a golf club with the golf stroke detection device;

FIG. 3 shows an example where a golfer wearing the golf stroke detection device is concentrating on a stroke (in a stillness sub-gesture);

FIG. 4 shows an example of a trajectory of the golf club head during a golfer performing an example of a typical full swing;

FIG. 5 shows an example of a trajectory of a detection device during a full swing;

FIG. 6A shows an example of an acceleration signal captured with a detection device during a full swing with a driver;

FIG. 6B shows an example of an acceleration signal when it is divided into separate swing phases;

FIG. 7A shows main electrical components of the stroke detection device;

FIG. 7B shows an exemplary layer diagram of the division of the recognition algorithm between the processing units of the stroke detection device and a mobile device;

FIG. 8 shows as a flow chart an example of a stillness recognizing procedure in the stroke recognition system;

FIG. 9 shows as a flow chart an example of a hit recognizing procedure in the stroke recognition system;

FIG. 10 shows as a flow chart an example of a peak recognizing procedure in the stroke recognition system;

FIG. 11 shows as a flow chart an exemplary overview of a complex recognizing procedure in a system;

FIG. 12A shows an exemplary golf hole with mapped polygon objects;

FIG. 12B shows a convex hull method to combine tee box objects;

FIG. 12C shows a non-convex hull method to combine tee box objects;

FIG. 13 show a method for changing hole automatically based on mapped golf course data;

FIG. 14 shows a method for changing hole based on detection of strokes;

FIG. 15 shows a close-up of green surroundings with location data used to configure the impact detector;

FIG. 16 shows an example of generalized stroke recognition algorithm having three main stages;

FIG. 17 shows recorded tri-axis acceleration signals from a drive and a putt shot;

FIG. 18 shows output of the exemplary hit recognizer for a full-swing stroke;

FIG. 19 shows a cross-correlation process with location based configuration and its output for a full-swing stroke;

FIG. 20A shows an exemplary post-filter for removing false positive recognitions outside of the extended green object; and

FIG. 20B shows an exemplary post-filter for removing false positive recognition within the green object.

### DETAILED DESCRIPTION OF THE INVENTION

In the following description, considered embodiments are merely exemplary, and one skilled in the art may find other ways to implement the invention. Although the specification may refer to “an”, “one” or “some” embodiment(s) in several locations, this does not necessarily mean that each such reference is made to the same embodiment(s), or that the feature only applies to a single embodiment or all embodiments. Single feature of different embodiments may also be combined to provide other embodiments.

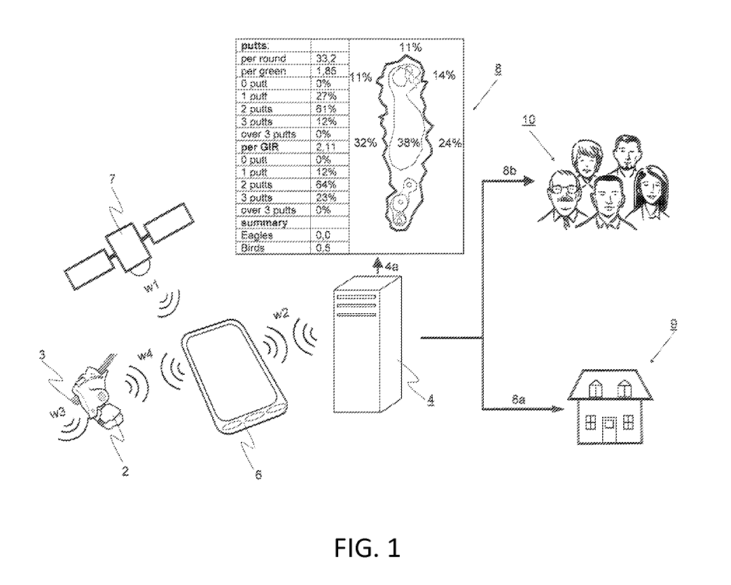

An exemplary embodiment of an advanced electronic caddie system, CaddieON®, is shown in FIG. 1. The electronic caddie system comprises golf club identifier tags (reference 3 in FIG. 2) on the golf clubs, advantageously a wrist-borne golf stroke detection device 2, a mobile device 6 (for example a smartphone) and a backend server 4. The golf club identifier tags 3, the golf stroke detection device 2, the mobile device 6, and the backend server 4 are connected together wirelessly; references w4, w2, and w3 in FIG. 1.

The player installs the computer program accomplishing the procedure according to the invention on his or her mobile device 6 and marks his or her golf set with the club identifier tags 3. The mobile device 6 may be for example a smartphone, a tablet or a laptop. The golfer has activated a wireless connection between the stroke detection device 2 and the mobile device 6, reference w4. The golfer wears the stroke detection device 2 on his or her wrist or forearm during the game. The stroke detection device 2 reads the club information from the tag 3 before a stroke is taken, records the stroke and transfers data to the mobile device 6. The mobile device 6 advantageously combines stroke data with the available location information, for example satellite 7 based location information (GPS, Glonass, etc.) (reference w1).

By utilizing the stroke detection device 2 according to the invention the golfer can better focus on his or her game during the round of golf. The mobile device 6 keeps track of all the strokes that the stroke detection device 2 has indicated during the game. Advantageously it offers a review and manual editing options for the player as well. Game data 8 is stored to and made available 4a simultaneously on the backend server 4, reference w2. The player can choose to get quick feedback about the status of his or her game on the display of the mobile device 6 at any time during the round through application views such as scorecard, rangefinder or course map. Advantageously also other relevant information is available, for example a ball lie can be recorded and information about weather conditions is available. This adds value to analysing the round and thus improving the skills more comprehensively.

The electronic caddie system can also suggest suitable game strategy like a stroke plan and clubs based on the golfer's former statistics and course information available online from the backend server 4. The backend server 4 offers a personal portal for accessing and analysing the game afterwards. There can be a separate portal for golf instructors so they can get more detailed information about their group. The server collects also versatile course and game data for the golf course operators 9 to improve the playing experience and thus the attractiveness of the course.

There are thirteen clubs and a putter in a typical golf bag. The player attaches a tag 3 to each of the clubs so that the clubs can be identified when a stroke is about to be taken. Tags 3 can advantageously be based on any wireless technology like RFID (Radio Frequency IDentification) or NFC (Near Field Communication). The tag may also be an entity including optically readable code that can be attached to the golf club. An individual code, club ID, may be written to the tags 3 when they manufactured or unique ID (UID) of the underlying RFID inlay may be utilized. The swing detection device 2 includes advantageously an integrated reader antenna that is brought to a close proximity of tag 3 so that tag ID can be read either wirelessly or optically. An advantageous position of the tag 3 is on the grip or at the end of the club or on the shaft. That way the reading experience of the club ID from the tag 3 is most convenient. Antenna of the stroke detection device 2 is designed so that reading performance is optimal for the tag 3. In one advantageous embodiment the antenna is embedded into the wrist band of the stroke detection device 2.

A 3-axis accelerometer records stroke related data enabling reliable detection of the very moment when the club hits the ball. The hit recognition algorithm according to the invention runs advantageously on the microprocessor in the stroke detection device 2 or alternatively in the mobile device 6. Naturally, the algorithm can also be partitioned between the existing processors as seen feasible in the chosen embodiment. The complete algorithm comprises several algorithms in which sub-gestures characteristic to a particular stroke gesture or event are utilized. In this context a gesture means a physical movement of the golfer that is visible to the human eye. A sub-gesture is a part of a longer, continuous gesture made by the golfer. One part of the algorithm according to the invention is simple enough to be implemented for example with a state machine that can be found in the prior art accelerometers.

Different hardware (for example field-programmable gate array (FPGA) and software implementations for all algorithms according to the invention are possible. The stroke recognition procedure provides improved power efficiency that means a longer overall usage time. The stroke recognition system according to the invention allows utilizing multiple algorithms for different types of strokes and clubs. The algorithms can be executed simultaneously in different entities of the electronic caddie system or one at the time. Club ID or golfer position on the golf course can advantageously be used as a parameter for selecting the best detection algorithm. One may also choose to apply auto-adaptive algorithms in the future so that player specific gestures are recognized better.

One part of the personal electronic caddie system according to the invention is an application that runs on the mobile device 6. It can be used as a stand-alone golf application but advantageously it may be used in conjunction with a backend server 4 (reference w2). The mobile device 6 can be based on any platform providing needed software tools for 3^{rd} party developers, methods for installation of downloadable application, access to satellite 7 positioning, (for example GPS or Glonass, reference w1), and wireless data connectivity sub-systems (for example Bluetooth, WLAN or a cellular connection, references w2 and w4). Some smartphone platforms of this kind are for example Android, iOS and Windows Phone, but there are proprietary platforms to which the electronic caddie system can be implemented.

The application implements an user interface having several informative display views to be utilized during a round of golf. The main ones are as follows.

The main view is utilized for making golfer and game related basic settings, selections and preferences. The golfer can advantageously use the view to choose to enter player data; basic application settings; stroke detection device 2 and club 5 set settings; selection of course to be played; and to start the game. Extra information of the local weather, golf course operators' events etc. can be offered to the players through news feed.

The scorecard view is an electronic version of golf scorecard indicating basic data of on-going game such as the number of the played hole, its par value and number of strokes the player has taken. Scorecard data is based on individual course data that is collected automatically and confirmed by the golfer. The scorecard is transferred to the player portal on the backend server 4 after the hole has been played or the round completed. Besides by the player himself, the results could be utilized by different golf information systems for example for tournaments, competitions and calculating handicaps.

The strokes view presents stroke information for a single hole as a chronological list, i.e. a stroke number, club used, ball lie, and distance per stroke. Data collection is automated by the electronic caddie system but before storing the data a golfer reviews and confirms the list. To add penalty strokes or, in a case where there are errors in the collected data, an option to edit each line as well as delete and add strokes are advantageously offered. The finalized list is utilized by the scorecard view and synched to the backend server 4.

In order to collect correct stroke data it is vital to have exact pin location of the hole. With the set pin location feature of the application the golfer can set the exact pin location of the played hole. Utilizing mapped green object 125 of the played hole 127 the green view is displayed to the golfer where the pin 126 is set either using the golfer's GPS location or the golfer can manually adjust the correct pin location. Alternative ways to set pin 126 is to utilize RFID tag located in the pin flag or the green cup which is read using an RFID reader 23 located in the stroke detection device 2. Or accelerometer 22 attached to the golfer's wrist can be used to recognize gesture to set pin location together with the golfer location information. An example gesture can be double tap of stroke detection device or to model the hand movement using accelerometer when the golfer picks up the golf ball. After completion of the round all changed pin locations are synched to the backend server. It is also possible for golf course operator 9 to provide the correct pin locations of the course via golf course operator portal located in the backend server 4. Updated pin locations of the golf course are available also to other golfers playing the same golf course. When other golfer starts a round updated pin locations are downloaded along the course data from the backend server to the application on the phone.

The range finder view is a summary presentation showing distances to points of interest (objects) on the current hole. Specifically the distance from the golfer to the flag and known hazards are calculated based on the measured location and the electronic map information. This information helps planning the remaining strokes and selection of the suitable clubs. The location is measured with the positioning sub-system on mobile device 6 and information about objects is fetched from the course database on the backend server 4.

The map view is a graphical map view of the golf course. It combines relevant parts of the strokes view and the range finder views with free online map data such as Google Earth. Positions of each taken stroke, the current position of the ball, the game plan to the green, the position of the flag and locations of hazards are overlaid on the map. On golfer's choice also stroke positions and their end results from the previous rounds can advantageously be overlaid on the map by making a simple database query. An actual distance of taken strokes and a distance of the planned strokes and from the ball to the hazards can be shown. A projected ball landing area for planned strokes can be calculated and made visual on the map. They are based on the golfer's history data of the stroke accuracy.

Planned strokes can advantageously be edited on a touch screen of the mobile device 6. Also a suggested club for the next stroke or other relevant information may be shown. The map can be zoomed and panned on the touch display with fingers or automatically when the game proceeds and the player is for example approaching the green and requires a more detailed view. Measuring a distance between arbitrary points of interest is also possible. Also the position of other players using the electronic caddie system can be overlaid on the map. In that way it is possible to warn a player from taking a shot if other groups are within the reach of the striking distance of the player. This feature improves the safety on the golf course especially when the player has no visibility to the projected ball landing area.

The electronic caddie system also offers many other possibilities to provide useful information to the player. Highlights after the game (the best/longest strokes for example), notification of other players' performance after storing the scorecard and a history view (for example a summary of the player's previous scores on the current course), to mention a few.

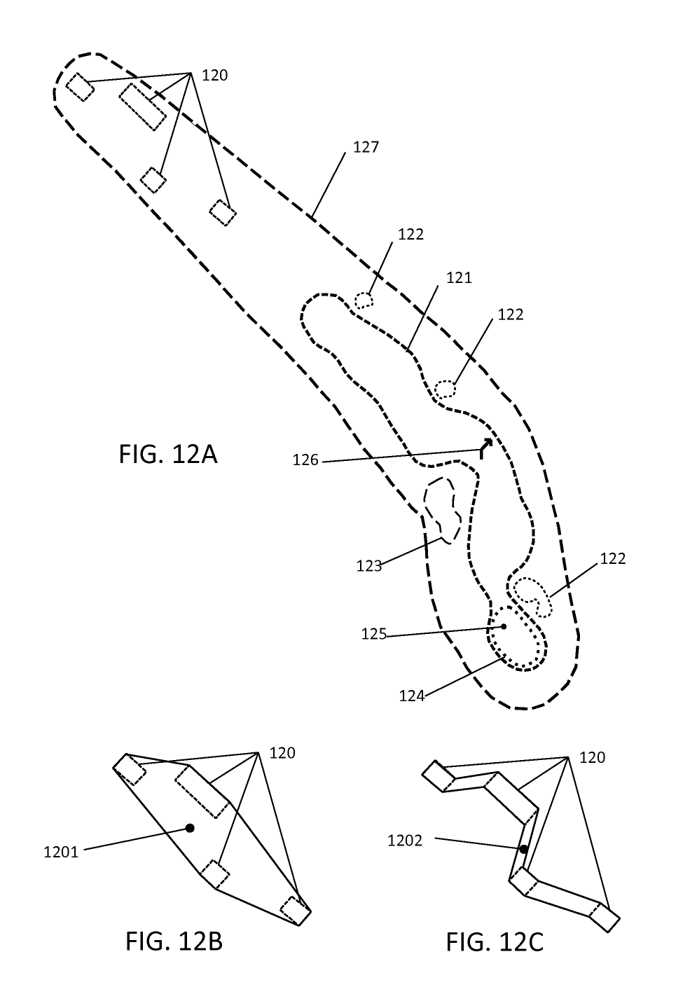

The electronic caddie system is also able to detect the ball lie automatically. Different surfaces on each hole of the golf course (i.e. tee boxes, fairways, greens, sand hazards) are mapped defining a set of coordinate points from the boundary of each object. The coordinates may form a polygon and each polygon is advantageously identified for a type of surface they represent. FIG. 12A shows an exemplary overview of the polygon objects of the mapped hole object 127 consisting of tee object(s) 120, fairway object(s) 121, hazard objects (bunkers) 122, water hazard(s) 123, green object 124, pin 125 and pivot point(s) 126. The coordinate set of each object (or polygon) is uploaded to the application before the golfer starts to play. When the stroke detection device 2 detects a stroke, it sends the information to the mobile device 6. The golfer's coordinates given by the GPS receiver of the mobile device 6 are checked against the coordinate data of the polygons. When the golfer's coordinates fall inside a defined polygon, the type of surface of the polygon is given to the stroke. These method steps can advantageously be implemented on the mobile device 6 or on the backend server 4.

The electronic caddie system is also able to filter strokes recognized from the same location automatically. It is common that the golfer takes practise shots before actual shots for example when teeing off, taking fairway shot or approach shot. In these cases it is highly possible that practise shot is recognized as actual shot because of similarities between shots i.e. practise shots are recognized as a stroke because the golfer's club has impacted the ground. Utilizing automatic ball lie detection method it is possible to filter consecutive strokes recognized from the same location. For example the golfer takes shots on the fairway 124 and several strokes are recognizes from the same location the electronic caddie system records only one stroke from that location as the other strokes are presumably practise shots. On the other hand if several strokes are recognized from the bunker object 122 strokes are not filtered, since the golf rules prohibit the golfer to touch the sand with his club until the point of impact during the stroke, so extra recognitions are unlikely. Also when the golfer is on the green 125 recognized putts are not filtered because it is highly possible that the length of putts are so short so it is impossible distinguish putts from each other within the GSP accuracy. Moreover, golfers normally don't take practise shots on the green so that the putter touches the green surface.

The electronic caddie system is also able to remind the golfer to read the golf club identifier tag if the golfer forgets to read the tag before the stroke. When the stroke is recognized and if the golf club identifier tag is not read since the previous stroke the electronic caddie system compares the club information of these strokes. If the identifiers are the same and the strokes are separated by predefined distance or ball lie information differs between strokes, reminder (vibration or audible notification) is given to the golfer to read the golf club identifier tag. The reminder is also given if the detected stroke was the first stroke of the hole and the club information is not available which indicates that the golfer has forgotten to read the golf club identifier tag because when the hole is changed the club information is also cleared. If the golf club identifier is read within the predefined timeout from the recognized stroke, club information is updated. If the golf club identifier is not read the existing club information is valid for the recognized stroke. When the golfer is on the green 125 the reminder is given only once if the golfer has forgotten to read the golf club identifier for the recognized putt. If more putts are recognized on the green 125 those are assumed to be done with the same putter and therefore the reminder is not given.

The backend systems of the electronic caddie system comprise advantageously the following main parts: a web server 4 and a database connected to it, portals for players and the golf course operator 9, and communication interface.

Users can access the web server 4 at any time with a browser running on the mobile device 6 or on a personal computer. They are for example able to study information about golf course operators 9, available courses and personal game history before the game. The electronic caddie system application utilizes a specific application programming interface (API) to communicate with the backend server 4.

The database contains information about the registered golfers and golf course operators 9. The information, reference 8, may also comprise player profiles, scorecards and detailed game history, contact information of golf course operators and course details (number of holes, course rating, scorecard, flag position, etc.). Also player and game related information may be collected and uploaded online during the game by the mobile device 6. Information related to the golf course operator 9 is maintained by a service provider.

The backend server 4 advantageously analyses the stored data and provides versatile statistic and graphic views for players and golf course operators 9 (reference 8a) through dedicated portals. Scheduled calculation routines calculate aggregated statistics for various sizes of geographical areas or entities (i.e. global, country, and golf course specific) from all played golf rounds of all players.

The player portal shows measures and development of golfer's own game. It also gives possibilities to share information about played games in social media or directly to other registered users and portal visitors 10 (reference 8b). Individual golfers can compare their statistics with other golfers according to different geographical areas or entities like global, country, or golf course. The golfer can also compare his or her statistics with the average values of all golfers in different categories, based on the total number of strokes. For example, a golfer can choose to compare his or her statistics against the average of all golfers, whose round score is between 11 and 20 strokes over par or with golfers whose score is between 21 and 30, and so on. Moreover, the system enables handicap calculation and statistics down to individual club.

The golf course portal is the view for the operator 9. It shows current positions of all players using the electronic caddie system. History data shows how the course has been played: the route players have taken on the course, where they have stroke the ball from. This information can be used to proactively identify wearing on the course or monitor round durations. Aggregated data from the golfers can be pro-vided back to them through course specific web pages showing for example an average playing time on the course, the difficulty of each hole, daily highlights from the field, etc. These types of views can be easily generated on need basis.

Communication between the electronic caddie application in the mobile device 6 and the backend server 4 is advantageously done through representational state transfer (REST) API, which has the following functions: uploading game results (scorecards), searching golf courses and downloading course information, and logging a player position during a game. Actions can be initiated from the mobile device 6 side against the backend server 4 or alternatively two-way messaging via mobile push notifications can be used.

FIG. 2 shows an exemplary situation where a golfer 1 identifies wirelessly a golf club 5 by his or her stroke detection device 2 before a stroke. Each golf club includes an individual tag 3 that is connected to a golf club 5. Advantageously the tag 3 is fastened to the grip end of the club 5. Reference 5a depicts the head of the golf club. When the stroke detection device 2 has read the tag 3 of the present club, it advantageously transmits club identification information wirelessly to the mobile device 6 of the golfer 1 (reference w4).

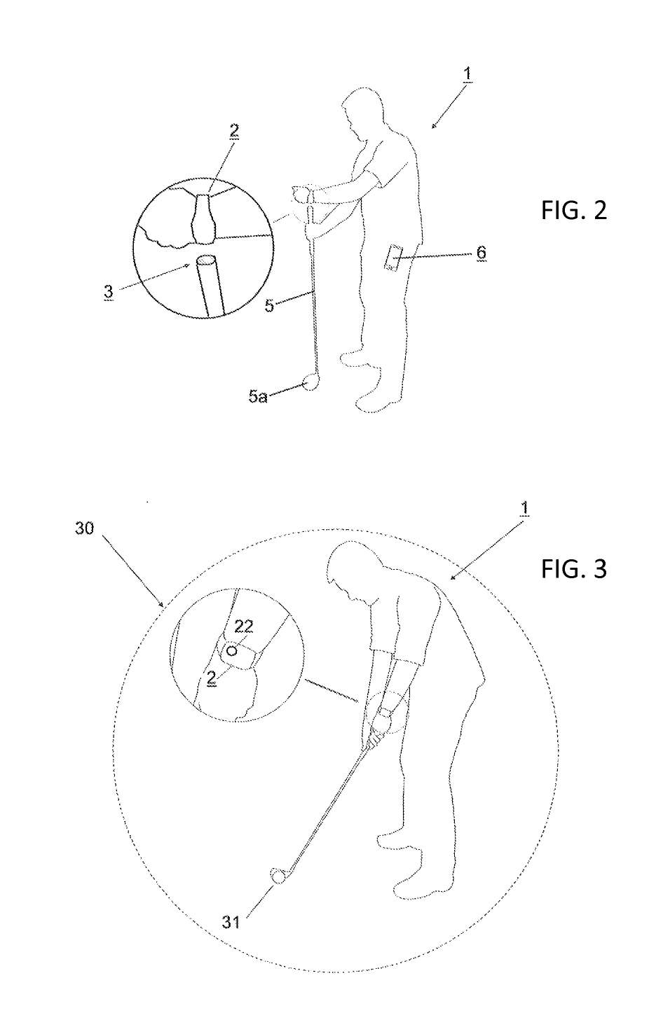

FIG. 3 shows an exemplary golfer 1 wearing a wristband type stroke detection device 2 that contains a motion sensor 22, for example an accelerometer. As can be seen in FIG. 3, the stroke detection device 2 will be near the grip of the golf club 5 during a golf stroke. In FIG. 3 the golfer 1 is addressing the golf ball 31 before playing a stroke. This address phase is hereafter called as a stillness sub-gesture 30.

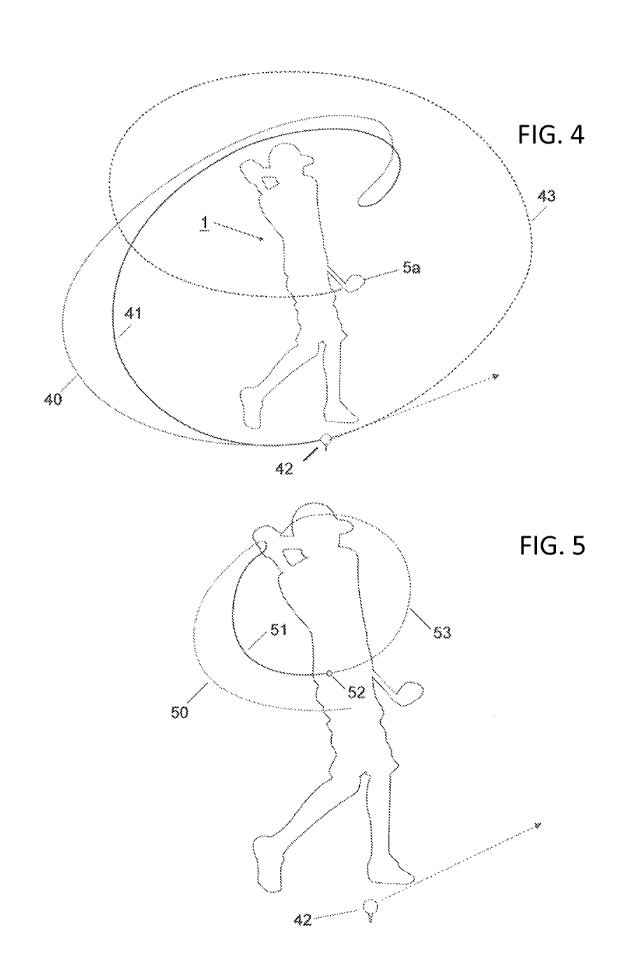

FIG. 4 shows a golfer 1 performing a full swing (full wave) with a driver club as an example of a typical golf swing. Let us consider a trajectory that the golf club's head 5a moves during the swing gesture. Said trajectory is typically divided advantageously into several sub-gestures. In this context a phase advantageously depicts an electric signal representing a sub-gesture and an event depicts a short incident during a gesture, for example a hit.

After ‘stillness’ 30 follows a ‘backswing’ 40 that is a sub-gesture where the golfer 1 brings the club head 5a back and up. The next sub-gesture is ‘downswing’ 41 where the golfer brings the club head 5a rapidly down to the ball. ‘The collision’ 42 is an event where the club head 5a collides with the golf ball. This may also be called as ‘a hit sub-gesture’ later on. The golf stroke ends up to ‘a follow through’ 43 sub-gesture where the golfer 1 brings the club head 5a forward and then to the pelvis level. While different kinds of clubs and swing types exist in the golf game, it is notable that all swings contain these same logical sub-gestures.

In order to detect said sequence of sub-gestures or motions, the stroke detection device 2 with a motion sensor 22 can be attached either to the golf club 5 or to the golfer's hand. From a detection point of view an advantageous position for the motion sensor 22 would be inside the head 5a of the golf club 5. A more feasible approach may be to firmly attach a separate detection device to the shaft of the golf club. However, from the golfer's point of view the most practical and economical solution is to use a single stroke detection device that can be attached to the golfer's wrist for the duration of a golf game.

In FIG. 5 is shown an exemplary trajectory depicting movements of the stroke detection device 2 during a full swing. The motion starts with a ‘backswing’ sub-gesture 50 where the hand of the golfer 1 moves back and up. A ‘downswing’ 51 sub-gesture follows the ‘back swing’ sub-gesture. In the ‘down swing’ sub-gesture 51 the hand moves rapidly down and forward drawing a half circle in the air. After the collision 42 with the ball 31 the stroke ends up to a ‘follow through’ 53 sub-gesture where the hand of the golfer 1 moves forward and up almost completing a circle.

In a case where the head of the club 5a collides with the ball during the swing the forces due to the collision with the ball make the club 5 to vibrate. This vibration travels through the shaft of the club 5 all the way to the golfer's hand and to the stroke detection device 2.

Series of motions of the hand clearly resemble the motions of a golf club's head as shown in FIG. 4. However, there are the following exceptions. An overall scale of the trajectory of the stroke detection device 2 is smaller than the trajectory of the golf club head 5a. Therefore, also the speed of change and magnitude of the acceleration are smaller. Also the trajectory in the transition phase from ‘backswing’ to ‘downswing’ is simpler and shorter. The collision with the ball is experienced only indirectly via the golf club shaft and the golfer's hand. Also the trajectory in the ‘follow through’ sub-gesture is shorter. These exceptions complicate making a reliable decision when a real stroke has been recognized.

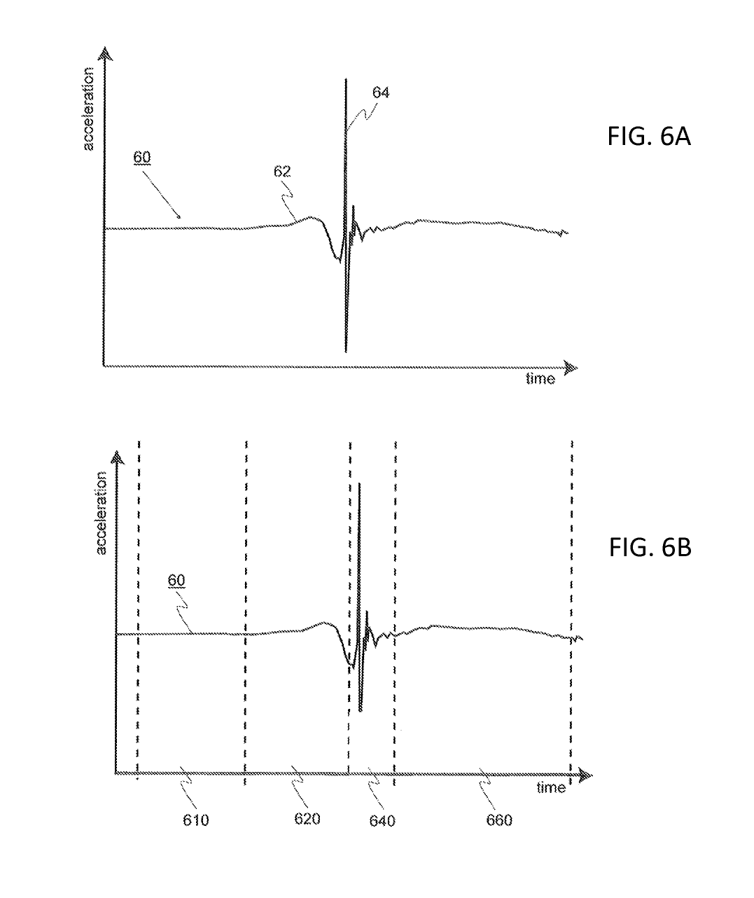

FIG. 6A shows an example of an acceleration signal 60 captured with the stroke detection device 2 according to the invention during a full swing with a driver club. The signal is an example of a typical acceleration signal in the golf game. The signal is captured with a 3-axis accelerometer sensor. For the sake of clarity only one axis is visualized in FIG. 6A. The acceleration sensor was firmly installed into a wristband type stroke detection device 2. The stroke detection device 2 was attached to the golfer's top hand holding the golf club 5.

The signal graph shows that an accelerometer 22 attached to the golfer's wrist can be used for producing a meaningful input signal for a golf swing recognizer algorithm because the signal 60 clearly responds to hand motions during a swing. When the amplitude 62 of the detected signal 60 changes, it reveals the collision 42 between the club head 5a and the golf ball 31. The collision can be seen as multiple sharp, high amplitude spikes 64. It is noteworthy that this oscillation due to collision is yet easily distinguishable despite of an indirect measurement via the club shaft, grip, glove, golfer's hand and the swing detection device body 2.

FIG. 6B shows as an example the acceleration signal 60 of FIG. 6A when the signal 60 is divided according to the invention to four main phases of a golf stroke. The main phases are ‘stillness’ 610, ‘swing’ 620 (back and down), ‘hit’ or ‘miss’ 640, and ‘follow through’ 660.

During ‘stillness’ 610 the golfer concentrates. He or she stands straight holding the club 5 with both hands so that the club head 5a nearly touches the ball on the ground. As the golfer tries not to move, the measured acceleration signal is typically very steady for a while and hence this phase is called ‘stillness’.

During ‘swing’ 620 the golfer slowly raises the club head (‘backswing’) and then rapidly swings it towards the ball (‘downswing’). The measured acceleration signal 60 contains first a gentle ramp to one direction (due to ‘backswing’) and then a steeper ramp to the opposite direction (due to ‘downswing’). Naturally the direction depends on the accelerometer polarity.

During ‘hit’ 640 (i.e. collision) the collision between the club head 5a and the golf ball 31 makes the club 5 to vibrate for a short period of time. This vibration travels via the club shaft to the golfer's hand and to the swing detection device 2. The ‘hit’ generates multiple declining sharp peaks of opposite directions in the acceleration signal. In the case of ‘miss’, this oscillating pattern is not present or is attenuated in the acceleration signal 60. During ‘follow through’ phase 660 the golfer gently decelerates the motion of the club while the club head continues to follow its trajectory and finally returns the club to the initial position. The measured acceleration signal 60 contains a gentle ramp to one direction and after a moment another gentle ramp to the opposite direction.

According to the invention, the phases of the golf stroke (i.e. ‘backswing’, ‘downswing’, ‘collision’, ‘follow through’) and related sensor signal parts (′stillness′, ‘swing’, ‘hit’ or ‘miss’, and ‘follow through’) are essential to such golf stroke recognition algorithm. Therefore, the golf stroke recognition algorithm according to the invention is based on phases depicted in FIG. 6B. The purpose of the golf stroke algorithm according to the invention is to recognize and notify when a golfer hits a ball. Therefore, the primary requirements for such algorithm include capability to detect a golf swing from other motions and when recognizing said golf swing, capability reliably to separate between ‘hit’ and ‘miss’.

Secondary requirements may be a reasonably fast response time to notify about a ‘hit’ soon after swing gesture. Also low power consumption makes possible a mobile, battery powered stroke detection device that has a long operating time. Also efficiency in terms of processing power and memory consumption facilitates a commercially feasible consumer class product.

When a captured acceleration sensor signal 60 is fed into the algorithm according to the invention, it will output a result that is either positive (i.e. ‘hit’) or negative (i.e. ‘miss’). In the case of a positive output the algorithm brings out that the acceleration signal 60 contains a golf swing with a ball hit. In the case of a negative output the algorithm brings out that the acceleration signal 60 does not contain a golf swing at all or that the player missed the ball.

An output of a stroke detection algorithm can be correct or incorrect depending on the algorithm's capability to accurately classify different kinds of signals. By giving a label ‘true’ to depict correct output and ‘false’ to depict incorrect output the algorithm's outputs can be further classified to four groups based on their correctness. The output can be true positives (TP), false positives (FP), true negatives (TN), and false negatives (FN). An ideal recognition algorithm outputs only true positives and true negatives. Detection algorithms known in the art more or less frequently fail in this classification and output also false positives and false negatives.

The definition given above contains dualities. For each appearance of a false negative output there will be a true positive output that is missing. Both illustrate an error where the utilized recognition algorithm failed to recognize a golf swing with a ball hit. Likewise, for each appearance of a false positive output there will be a true negative output that is missing. Both illustrate an error where the utilized recognition algorithm notified about recognition of a hit when the signal actually did not contain a golf swing with a ball hit. Hence, if the test signals are known, the performance of the recognition algorithm in terms of a correct classification of input signals can be fully understood with using either the terms true positive (TP) and false positive (NP) or true negative (TN) and false negative (FN).

During a game of golf most of the playing time is spent in activities other than hitting the ball such as moving to a new location, waiting for own turn, or practicing swings without hitting a ball. As a consequence, negative output from the recognition algorithm is far more expected than a positive output. This makes the positive outputs more interesting and convenient to focus on in analysing the recognition in the algorithm. In the following description true positives (TP) and false positives (FP) are used in the description to depict recognition algorithm's decision making capability instead of their negative counterparts.

Any recognition or detection algorithm tries to maximize the amount of true positives and minimize the amount of false positives. A common consequence of an attempt to increase the classification accuracy of the recognition algorithm is that the recognition algorithm becomes more complex. This added complexity usually means spending more CPU cycles and memory and hence also more power, which is a limited reserve in a battery-powered mobile device.

Battery power can be saved remarkably by dividing the recognition algorithm into multiple stages where each stage has its own computer program module. In an exemplary case an acceleration signal of a golf stroke may contain a ball hit. The original, complete signal is advantageously given to the lowest stage for execution. The lowest stage has the least accurate recognition algorithm but also the lowest power consumption. In a case where the recognition algorithm generates a positive output from the complete signal relevant parts of the complete signal are propagated for ex-amination to the next higher stage that includes a more capable recognition algorithm. The highest stage with the most accurate recognition algorithm (with also the highest power consumption) makes the final decision about the ‘hit’ or ‘miss’. The decision can take place only if the complete signal reaches the highest stage of the recognition algorithm. However, a negative decision can be made already before that. With the recognition algorithm high momentary power consumption is minimized by limiting running time.

By utilizing the recognition algorithm most power consuming components can be kept in low power mode most of the time. However, a full processing capacity is available when needed. Therefore, maximum recognition accuracy can be achieved.

A basic rule of the recognition algorithm according to the invention is that any stage of the recognition algorithm must not reject any true positive indication. However, any single stage does not need to reject all false positives but any source for false positives should be blocked by at least one stage of the recognition algorithm. In the recognition algorithm according to the invention all true positives (TP) pass all stages and all false positives (FP) get blocked at some stage of the recognition algorithm according to the invention.

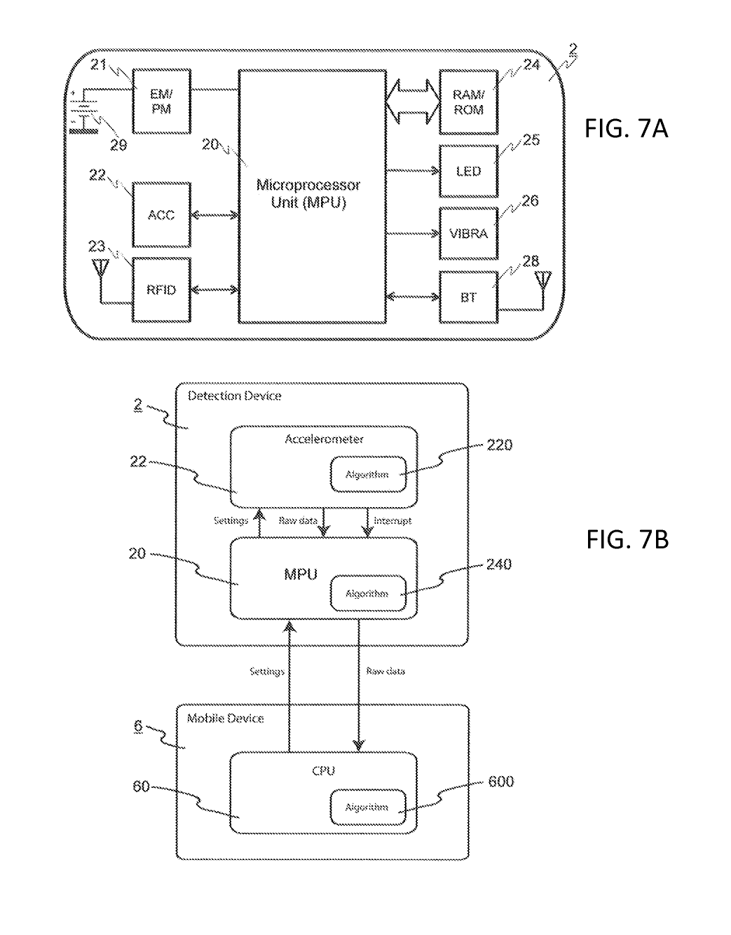

FIG. 7A shows, by way of example, main functional parts of the stroke detection device 2. The stroke detection device 2 advantageously comprise a microprocessor unit 20 (MPU) with a memory unit 24 (RAM/ROM), an RFID reader 23 with an integrated antenna, a motion sensor, for example a 3-axis accelerometer 22 (ACC), a gyroscope, or a magnetometer, a Bluetooth connectivity module 28 (BT), a led (LED) 25 and a vibra motor (VIBRA) 26 for user feedback. The stroke detection device 2 comprises also a battery 29 and a power/energy management circuit 21 (EM/PM).

The stroke detection device 2 may be connected to the mobile device 6 via a wireless connectivity link w4 such as Bluetooth. The link is mainly used for transferring raw or processed acceleration data of the stroke events, parameters and control messages. Communication periods are advantageously optimized in order to achieve better power efficiency and longer operation times. Other functionalities like updating the firmware of the stroke detection device 2 over-the-air are also possible.

The vibra motor 26 and led 25 are used for giving necessary indications and feedback to the golfer. Golfer disturbance should be minimized in all cases. Blinking and different colours of the led 25 are used for informing about the modes of the stroke detection device 2 (i.e. power on indication, battery status and charging state) as well as possible fault situations. The vibra motor 26 can advantageously be used for giving discreet notes of some key events such as successful tag reading, ‘hit’ detection and if the mobile device needs attention. The golfers can advantageously also opt for not using the vibra motor 26 by configuration options.

The accelerometer 22 may be utilized also for detecting some simple user commands. A user command may be defined for example by a number of taps or any other detectable gesture like hand shaking. A double tap may advantageously mean ‘end of course’ and hand shaking ‘start of course’, for example. The exact meaning is implementation dependent.

FIG. 7B shows an example how the recognition algorithm may be divided into computer program modules between the stroke detection device 2 and mobile device 6. A natural extension to the previous is that different recognition algorithm stages do not need to be run on the same physical component inside the stroke detection device 2. On the contrary, dividing recognition algorithm stages to different processing units a remarkable power saving is achieved as a technical effect.

FIG. 7B shows an example of an algorithm division into multiple processing units in a caddie system herein. The stroke detection device 2 is a physical entity that contains the motion sensor 22, for example an accelerometer, and hence must be attached to the golfer's hand or the golf club in order to capture the motions. The accelerometer component 22 may comprise a programmable logic and therefore it can advantageously execute the first stage of the algorithm 220 (i.e. a first program module) while the rest of the caddie system is in low power mode. A positive recognition from the first stage of the recognition algorithm wakes up the microprocessor unit 20 (MPU) with an interrupt.

Thereafter streaming raw accelerometer signal to the MPU 20 begins after updating the accelerometer settings to this new operation mode. The second stage of the recognition algorithm 240 (i.e. a second program module) now runs on the MPU 20 of the stroke detection device 2. A positive recognition from the second stage of the recognition algorithm triggers advantageously a wireless communication with an external mobile device 6.

After this relevant parts of the raw accelerometer signal are then streamed to mobile device's CPU 60 after updating the accelerometer settings. The third stage of the recognition algorithm 600 (i.e. a third program module) now runs on the powerful central processing unit 60 (CPU) of the mobile device 6. If necessary, more stages may be added, for example wireless communication to a backend service that is running on a remote backend server cluster 4 (not illustrated in FIG. 7B). After the last stage of the recognition algorithm according to the invention the signal for the final output of the algorithm is given (i.e. ‘a hit’).

The above-depicted division of the algorithm into multiple hosts provides another remarkable technical effect. The MPU 20 of the stroke detection device 2 can be a light-weight component because it does not need to perform complex analysis on the acceleration signals in real time. Instead, the MPU 20 of the stroke detection device 2 can advantageously send a signal capture containing potential data for a hit recognition to the mobile device 6 for a more complex analysis. After that the MPU 20 can continue to execute a less complex second stage of the recognition algorithm for finding another potential signal. Hence, the recognition algorithm division into multiple hosts also provides the technical effect of running different recognition algorithm stages in parallel, which in turn allows one or more stages to process the signal non-real time and thus even more complex signal analysis.

It is obvious to a person skilled in the art that also other kinds of divisions are possible. The decision about the needed recognition algorithm stages depends for example on chosen system architecture, communication bandwidth and cost, as well as capabilities of the available hardware components. For example, if enough bandwidth is available from the stroke detection device 2 to remote server cluster 4, then in that case all processing could be performed in the cloud. It is also possible that an accelerometer sensor 22 may contain enough processing power to process the complete stillness, swing and hit detection recognition algorithm alone.

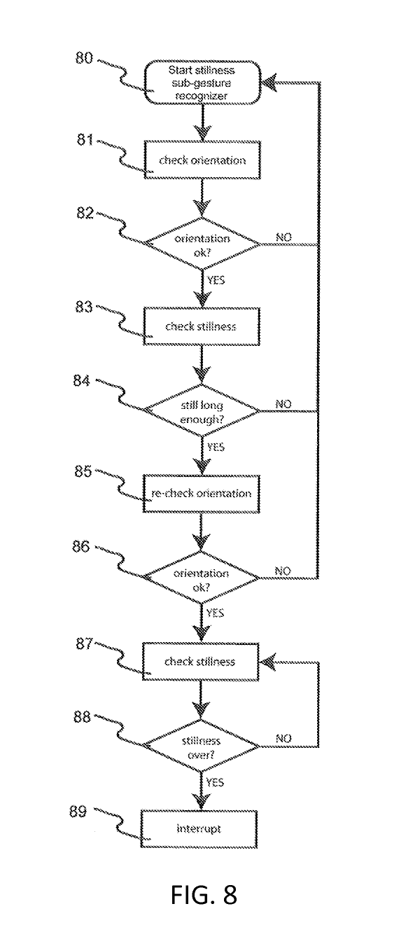

FIG. 8 shows an example of a stillness sub-gesture 30 recognizing procedure utilized in the algorithm according to the invention. The purpose of this stage of the recognition algorithm is to recognize the moment when the golfer concentrates on the upcoming swing. In this context some parts of the algorithm according to the invention may be called as a recognizer. A recognizer is a particular algorithm module configured to detect a particular swing sub-gesture or collision event. It may be hardware or a software based solution or a combination of them.

The stillness recognizer is best suited for the first stage of the recognition algorithm 220 because it is simple enough to be executed on the accelerometer's 22 logic part. Moreover, it removes the need to buffer data on the accelerometer 22 as all the other interesting signal parts come after it. This stage of the recognition procedure may advantageously be accomplished by a first program module executed in the accelerometer 22. The first program module may also advantageously be implemented as a FPGA hardware implementation.

The features to be observed from the acceleration signal include detection of an orientation and stillness of the stroke detection device 2, which can be observed either in parallel or in sequence. FIG. 8 shows an example of the latter where a state machine re-evaluates each acceleration signal sample. The procedure begins from start state 80 where variables are initialized. An orientation check state 81 determines the orientation of the stroke detection device 2 from one or more samples, for example by comparing the three signals from the 3-axis accelerometer 22 to pre-defined threshold levels. If the stroke detection device 2 is held still as assumed, only 1 g acceleration due to gravity is present. When the detected gravity vector is divided into three orthogonal signals, the current orientation of the accelerometer 22 can be detected.

Next, in state 82 a decision is made based on the orientation. The procedure will proceed to the next state 83 only if orientation resembles the golfer's posture in the concentration phase before a swing.

‘Stillness’ is then detected in a separate state 83, for example by requiring that the first difference of the vector form of the acceleration signal stays between two thresholds for a certain period of time. If this requirement holds long enough, then after state 84 the procedure proceed to the next state 85.

At this state 85 the orientation is checked again and the golfer's posture gets confirmed in state 86. In order to adapt to different concentration times, ‘stillness’ detection is performed again in state 87, but this time the procedure waits until stillness is over in state 88, i.e. until motion is detected. This motion is assumed to be due to the golfer beginning the ‘backswing’ and hence the sleeping MPU 20 of the stroke detection device 2 is now woken up with an interrupt in state 89.

Following the acceleration signal time-wise, after the stillness phase 610 comes the swing phase 620 and after that the hit or miss phase 640. In golf there are multiple different types of swings such as full swing, half swing, duff, pitch, and putt. Moreover, a golfer's personal style and experience is most visible in this phase 620. Hence, the recognition algorithm for swing phase 620 must tolerate much variation, which adds complexity to it.

On the other hand the next phase 640, ‘hit’ or ‘miss’, is much simpler to recognize partially due to very distinctive high amplitude peaks, partially due to a fairly limited pass band for frequencies that come from the club oscillation. Moreover, if a potential hit is not present in the acceleration signal 60, analysis can be stopped immediately and the more complex swing analysis 620 can be skipped altogether. Therefore, the ‘hit’ or ‘miss’ phase 640 is more suitable to be executed in the second stage of the recognition algorithm 240 than the swing phase 620.

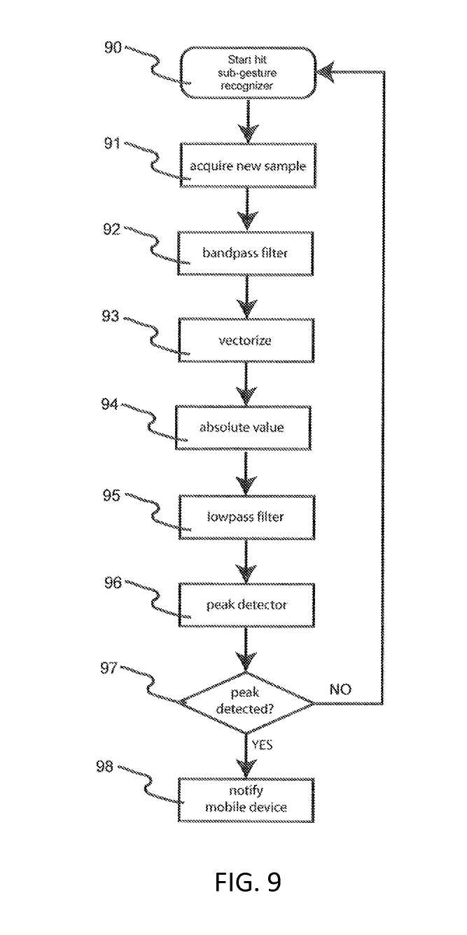

FIG. 9 shows an example of a hit recognizing procedure. The MPU 20 of the stroke detection device 2 has been woken up by an interrupt signal 89 from the stillness recognition procedure. The hit recognizing procedure is intended for the second stage of the recognition algorithm 240 and aims to recognize the moment when the club collides with the ball (i.e. impact). This stage of the recognition procedure may advantageously be accomplished by a second program module executed in the MPU 20 of the stroke detection device 2.

The hit sub-gesture recognizing procedure starts with initialization state 90. Next, a new acceleration signal sample is acquired from the accelerometer sensor 22, state 91. The acceleration signal comprises values from the accelerometer's X, Y, and Z axis. The sample is processed in state 92 with a band pass filter to attenuate all other than club oscillation frequencies. Next, the three values representing the 3-axis of the accelerometer 22 are combined to form a vector representation of the acceleration in state 93. The negative side of the acceleration signal is advantageously reflected to the positive side (i.e. compose an absolute value), state 94. The absolute value vector representation is then low pass filtered to smoothen the signal, state 95. As a result of these pre-processing steps, a ball hit appears as a single peak on the positive side, which can be detected with a fairly simple peak detector, state 96.

However, this recognition procedure may not distinguish for example a club hitting a ball from tapping the detection device 2 with a finger. Hence, if a potential hit is found, state 97, the mobile device 6 is notified, state 98, and relevant parts of the acceleration signal 60 are transferred from a local buffer of the stroke detection device 2 to the mobile device 6 for further analysis, i.e. to stage three of the recognition algorithm 600.

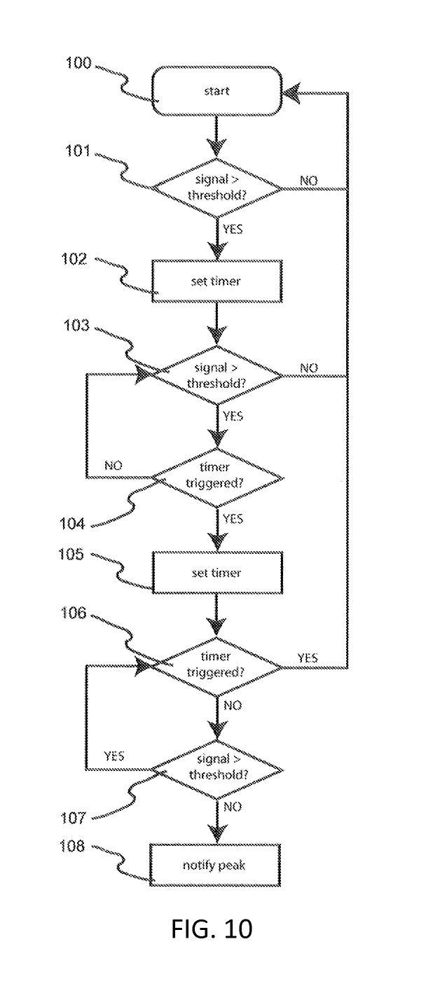

FIG. 10 shows an example of the peak recognizing procedure that is executed in states 96 and 97 of FIG. 9. While the band pass and low pass filters can be implemented for example with a classic FIR filter (Final Impulse Response), a peak detector design is not so obvious. The peak recognizing procedure is a part of the second stage of the algorithm 240 and it aims to recognize a peak that passes a pre-defined threshold level. In addition, the peak length is limited to minimum and maximum length.

The peak detection procedure starts with initialization, state 100, and then keeps on reading in new samples until one that passes a set threshold level is found, state 101. A potential peak has now begun and a first timer is initialized for measuring peak minimum duration, state 102. Samples are then compared against the set threshold, state 103, to ensure that the peak does not end prematurely before a minimum duration timer triggers in state 104.

If the found peak is long enough, state 104, a second timer is initialized in state 105 for measuring maximum duration of the detected peak. The second timer is advantageously not triggered in state 106 before the signal drops below a predefined threshold level, state 107.

When the signal has dropped below said threshold, a peak is notified in state 108 (i.e. state 98 in FIG. 9).

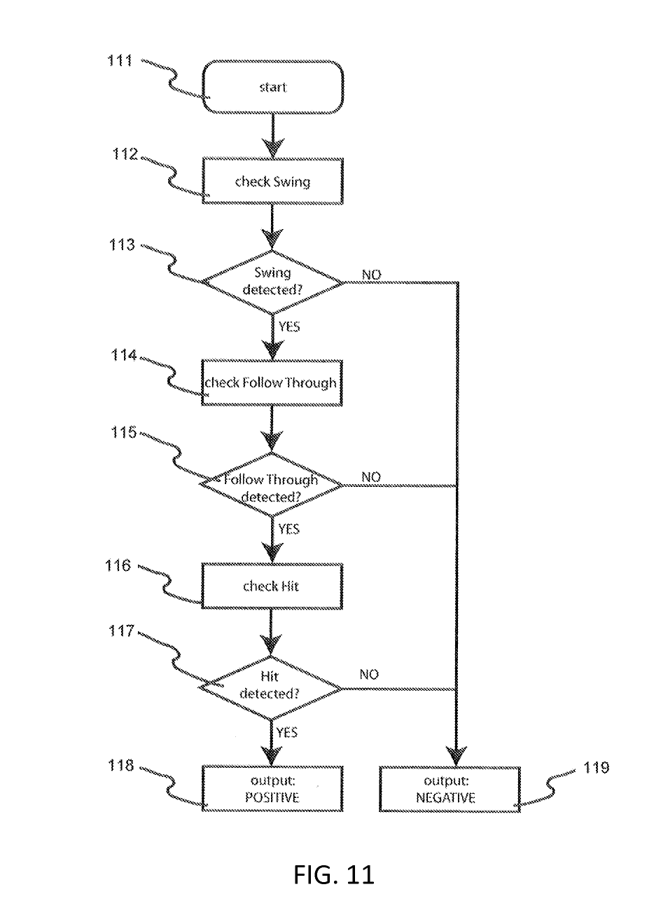

FIG. 11 shows an overview of a recognition procedure based on the last stage algorithm 600 that advantageously may be executed in the CPU 60 of the mobile device 6. A moment of stillness (state 89 in FIG. 8) and a potential hit (state 98 in FIG. 9) have already been detected by lower algorithm stages 220 and 240 that advantageously have been executed in the accelerometer 22 and/or in the MPU 20 of the stroke detection device 2.

The ‘follow through’ procedure will check from the buffered signal parts whether or not enough relevant features for a ‘swing’, ‘hit’ and ‘follow through’ are present. This procedure will output the final decision of the stroke recognition system according to the invention. This stage of the recognition procedure may advantageously be accomplished by a third program module executed in the CPU of the mobile device 6.

The last stage procedure starts from initialization, state 111, and proceeds to analyse ‘swing’ features, state 112. In this state 112 the procedure must take into ac-count different kinds of swing types in golf for example with multiple parameter sets. The implementation is advantageously based on cross-correlation with known swing signal model (target) coupled with a peak detector.

Alternatively the implementation may be based on mathematical methods applied in data fitting. Or the implementation may be a simple tester for the signal's rate of change such as a ramp detector. Or a state machine that tracks the signal form with thresholds and timers. Even a trained Hidden Markov model (HMM) may be utilized as a gesture recognizer.

If a ‘swing’ cannot be detected in state 113, the procedure immediately outputs a negative decision, state 119.

If a ‘swing’ is present in the signal, then a ‘follow through’ will be analysed, state 114, and tested, state 115, in a similar manner using similar techniques as in state 112.

If a ‘follow through’ cannot be detected, state 115, the procedure immediately outputs a negative decision, state 119.

If decisions in states 113 and 115 are both positive, the procedure moves to state 116.

At the end a more careful ‘hit’ analysis will be performed in state 116. In state 116 the goal is to reveal the signal pattern due to oscillating club and distinguish it from other high amplitude spikes such as tapping the detection device with a finger, clapping hands together, turning the detection device very rapidly or shaking the detection device.

There are at least three methods to reveal a ‘hit’ in decision making in state 117. In the first method an oscillation pattern of the golf club is searched for (e.g. via cross-correlation with a known signal model). If it is found, a positive result is outputted, state 118.

In a second possible method to reveal a ‘hit’ all known sources for false positive signals are rejected by explicitly looking for their features from the signal (for example via cross-correlation with a known bad signal). In that method a negative result is outputted, state 119, if any of the false positive signals are present.

In a third method a hybrid approach utilizing features of both the above-mentioned methods may be utilized.

Naturally, a recognition algorithm may give more weight on some features over the others, up to the point that some parts of the signal (such as ‘swing’ or ‘follow through’) may be omitted completely. Especially, if a club type can be detected, an algorithm tailored for the particular club type can be used. This approach can assist in acquiring good recognition accuracy when very different kinds of swings need to be supported. For example the recognition algorithm version for a driver club might be different than the recognition algorithm version for a putter club as these clubs are typically used for different kinds of swings.

Any of the recognition method steps or recognition procedure phases or states described and illustrated in FIG. 8-11 may be implemented by program modules including computer program instructions that are executable in a general-purpose or special-purpose processor and that are stored in a computer-readable storage medium (for example a disk, memory or the like). The program module may also be implemented by a FPGA circuit. References to ‘computer-readable storage medium’ and ‘computer’ should be understood to encompass specialized circuits such as field-programmable gate arrays, application-specific integrated circuits (ASICs), USB flash drives, signal processing devices, and other devices.

As herein presented, one of the advantageous features of an electronic golf tracking system like CaddieON®, exemplary embodiments shown in FIG. 1 and FIG. 7, is reliable hole change functionality. Commonly used methods are based on measuring the distance to the closest tee point(s) (method 1) or measuring the distance difference between the pin of the played hole and the tee point(s) of the next hole (method 2) or using the predefined distance (radius) around the pin of the hole (method 3).

Teeing areas of the hole are mapped as single coordinate points for each teeing area. In the method 1 the hole is changed when the measured distance of the golfer GPS location to the next tee point(s) is smaller than the predefined distance, whereas in the method 3 the change is done when the distance to the pin is greater than the predefined radius around the pin. In the method 2 when the measured distance of the golfer GPS location is greater to the pin location than to the tee point(s) the hole is changed.

The problem in the methods 1 and 3 is the need of the predefined distance. As the distance between the green and the tee area of the following hole varies depending on the course layout it is difficult to determine predefined distance value that works in all cases. When the teeing area of the next hole is very near to the played green and if the predefined distance value is too great the automatic hole change can happen too early, even when the golfer is still approaching the green or playing around the green. For example if approach shot was too long and the ball ended back of the green and if the distance from the ball to the next teeing place is smaller than the pre-defined distance the automatic hole change will happen when the golfer reaches the ball. The method 2 is also problematic when the teeing area is very near to the played green. As in methods 1 and 3 the automatic hole change can happen too early when the golfer is approaching the green or playing around the green since the distance from the ball to the next teeing place is smaller than to the pin location. Too early hole change will cause strokes are either missed or recorded to the wrong hole which will require the golfer to manually enter or edit stroke data.

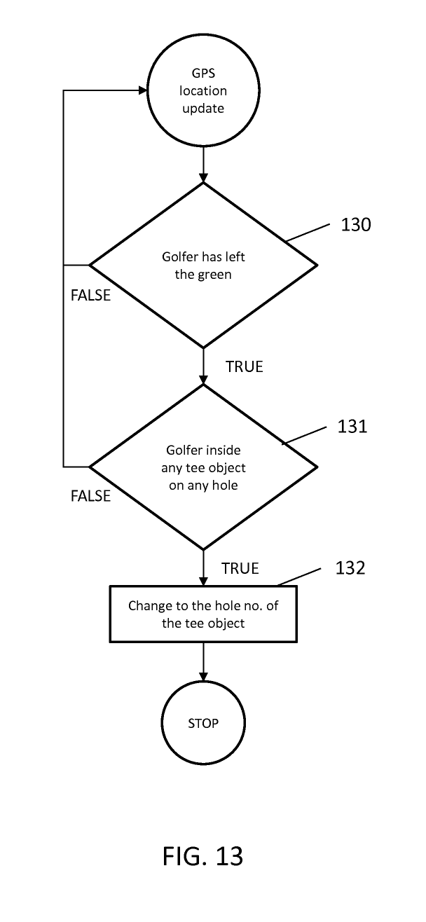

Better and more reliable procedure to implement the automatic hole change is to utilize the polygon objects of the mapped hole FIG. 12A. Instead of measuring distance the idea is to track the golfer surface location using the mapped objects of the hole FIG. 12A. FIG. 13 shows an example of the automatic hole change procedure. At the state 130 the procedure checks using the GPS location if the golfer has left the green 124 of the played hole 127. At the next state 131 the procedure will loop all the holes of the golf course and calculate if the GPS location is inside any tee object 120 of the hole. The calculation will be done individually for each of the tee objects 120 of the hole 127. If the result of the calculation shows GPS location is inside the tee object 120 of the hole the procedure will change to the corresponding hole at state. The ad-vantage of the used procedure is that all the holes of the golf course are calculated not only the next one because the holes of the golf course may be played in arbitrary order.

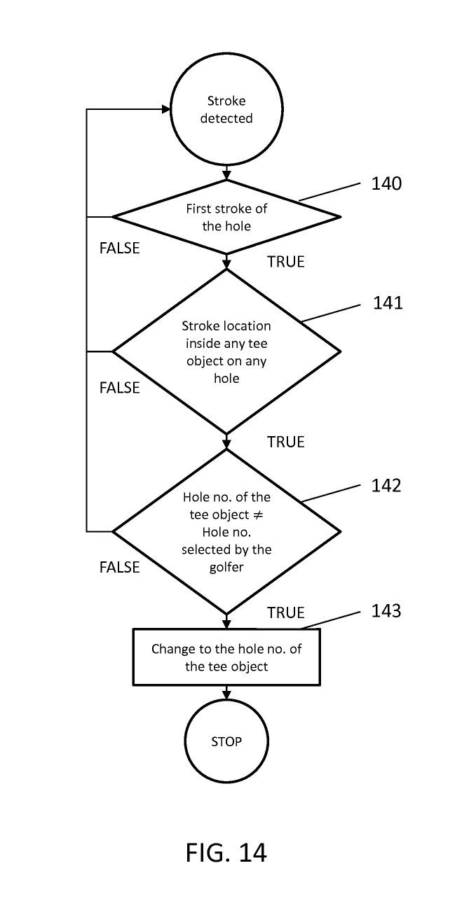

After a successful hole change it is possible the golfer will change back to the played hole, e.g. to check the score, and accidentally forget to change back to right hole or will change to a wrong hole. Based on the GPS location and the automatic stroke detection of the CaddieON system it is possible to check whether the golfer changed to the right hole. FIG. 14 shows an example of the verification procedure of the hole change based on stroke location. At the state 140 when the stroke is recognized the procedure will check if the recognized stroke was the first stroke of the hole. At the state 141 procedure will loop all the holes of the golf course and calculate if the GPS location of the recognized stroke is inside any tee objects 120 on any hole. At the state 142 if the GPS location was inside the tee object 120 of the hole the procedure will check if the hole number is the same than the hole selected by the golfer. At the state 143 if the hole numbers do not match procedure will change automatically to the hole found at the state 142. It is possible to modify the procedure to check the correctness of the hole after every stroke candidate by calculating if the GPS location of the stroke is inside any mapped object on any hole.

Alternative way for using single tee box of the hole is to combine the tee objects 120 of the hole 127 to one tee area object using convex hull algorithm FIG. 12B (1201) or non-convex hull algorithms FIG. 12C (1202). The usage of the combined tee area object instead of single tee objects makes the hole calculation procedure easier and faster to operate.

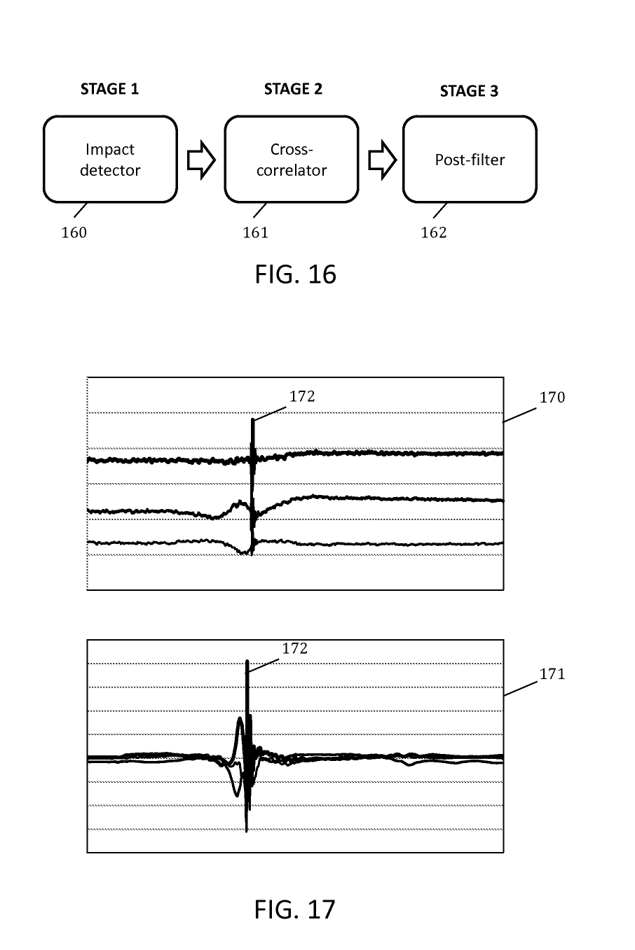

Course mapping data shown in FIG. 12A can be used advantageously to improve automatic stroke recognition algorithm accuracy. Due to live operating environment creating an accurate algorithm without mapped data is challenging. Indeed, course map data combined with information about the golfer's location on hole can be of great help. In an exemplary algorithm having three stages in FIG. 16, benefit can be gained in two ways: more reliable recognition of true strokes (stage 1 160 and stage 2 161) and enhanced rejection of false ones (stage 3 162).

A common challenge with any automatic golf stroke recognition system is wide range of different type of strokes taken during the round. Full swing and partial swing shots, pitches, chips and putts; they all have different swing and impact dynamics, which makes it difficult to develop general-purpose yet accurate stroke recognition algorithm. Number of failed recognition results may occur and some strokes may be missed due to too low sensitivity (False Negative result, FP). Or the opposite: if sensitivity is set too high some extra strokes may be counted although they were merely accidental knocks resembling a stroke (False Positive result, FP). Advantageously the characteristics of a golf stroke depend on golfer's location on golf hole. E.g. the closer to the pin 125 he/she is the gentler swing and impact, which can be understood by comparing signals from strokes like putts 170 and drives 171, which clearly have distinctive signals as seen in FIG. 17. Hence a sophisticated stroke recognition algorithm can be configured to variable game situations by utilizing pre-mapped golf course data outlined in FIG. 12A.

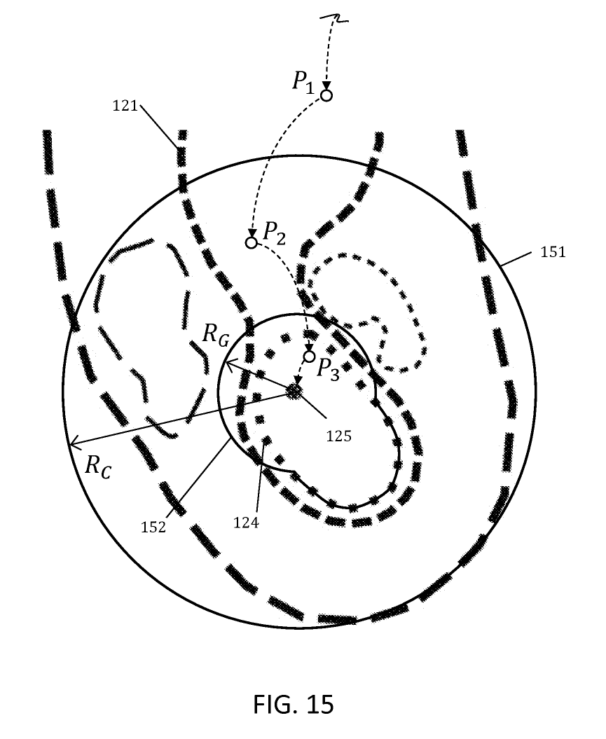

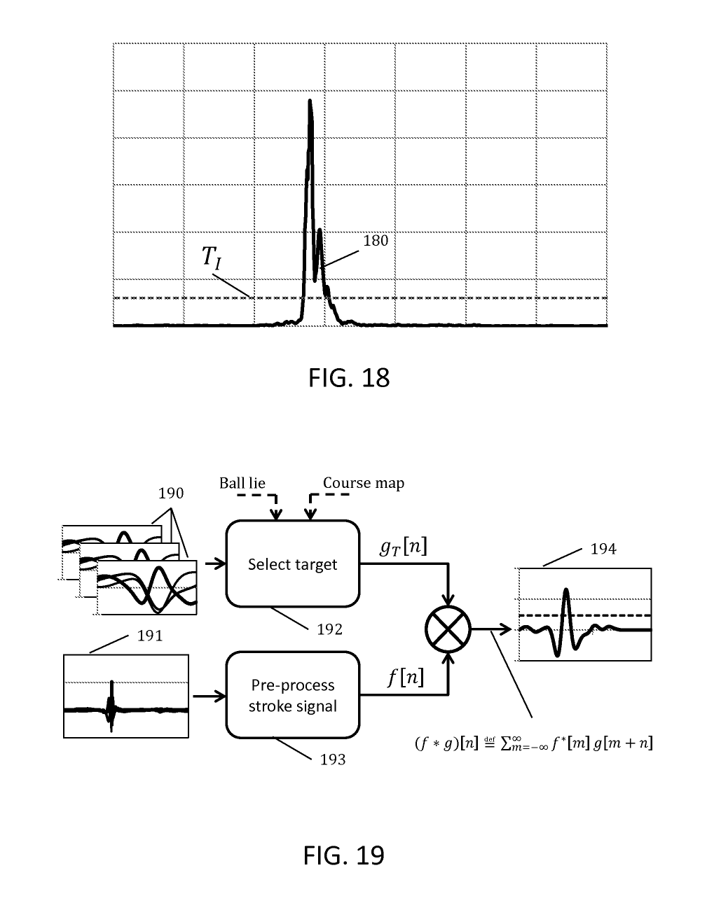

The recognition of a potential golf stroke starts in stage 1 160 with detecting the impact spike 172 generated by the club 5 collision with the ball 31. This can be done e.g. with the hit recognizer of FIG. 9-10. The processed output signal 180 is shown in FIG. 18. The detection threshold parameter T₁ could have different settings for fairway 121, close range 151 and green 152, meaning that the detection sensitivity gets gradually higher, i.e., threshold T₁ lower, when the golfer 1 moves away from the mapped tee object 120 to the fairway 121, finally arriving at the mapped green object 124 and close to the location of the pin object 125. As an example in FIG. 15 when approaching the green 124 the golfer 1 takes three strokes at locations P₁, P₂ and P₃. The threshold T₁ is still at the highest level at P₁, but is lowered well before P₂ when location Pₓ, is closer than R_{C} from the pin 125 and again to the lowest value before P₃ when entering inside the extended green object 152 which is union of the green object 124 and a pin-centric 125 circle with radius R_{G}. When moving away from pin 125, e.g. to the next hole, threshold T₁ can again be increases gradually. The exemplary embodiment 2 shown in FIG. 7 could have an accelerometer 22, whose range (g value) is dynamically configured along with the detection threshold T₁ of the hit recognizer.

More advanced recognition phases, such as cross-correlation 194 (f*g_{T})[n] of the recorded 191 and pre-processed 193 stroke signal f[n] with the stroke target 190 g_{T}[n] also known as a model, can follow in stage 2 in order to improve the recognition accuracy further, FIG. 19. The stroke target 190 g_{T} could be a full-swing, a pitch, a chip or a putt target or the algorithm could use combination of them for some stroke types. Target is selected depending where in the mapped hole the stroke was taken 192. E.g. when the ball lie falls inside the tee object 1201 the full-swing target is applied and when inside the green object 124 the putt target is applied accordingly. Similarly when the golfer is close to the green 124 like within close range 151 or inside a green side bunker object 122, chip or pitch type of strokes are likely to be taken, so a specific target 190 could be applied respectively or alternatively a combination of different targets could be applied.

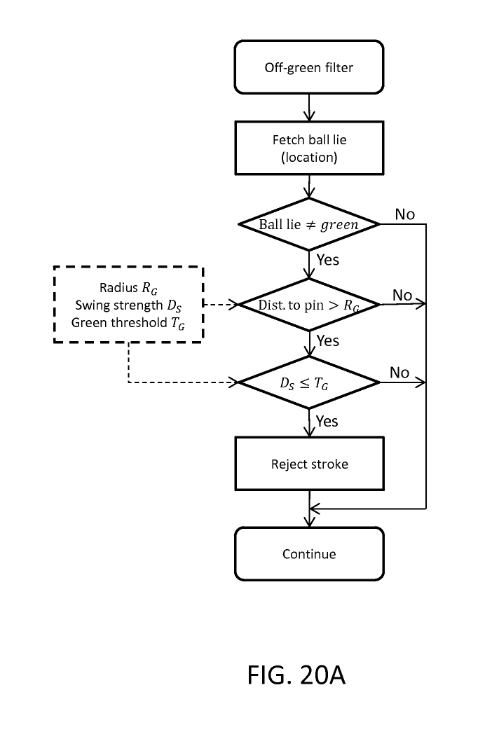

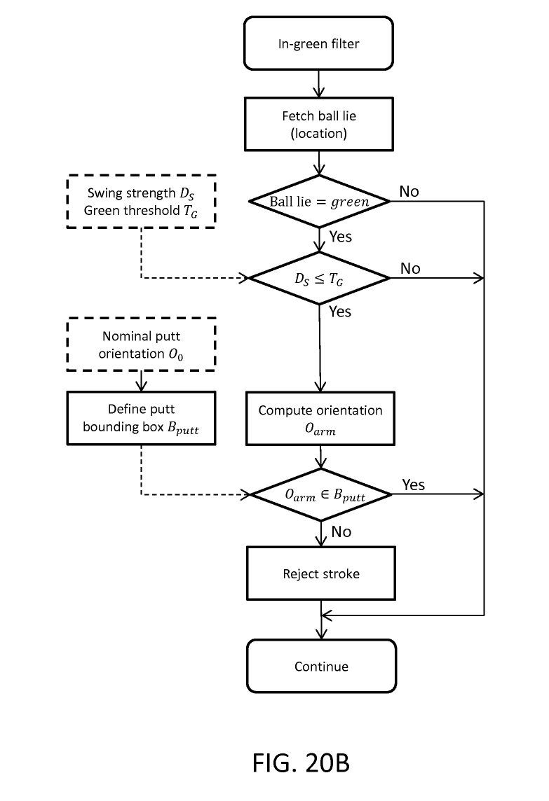

In stage 3 the false recognition results, i.e., false positives (FP), of the stroke recognition algorithm are removed with post-filter 162. There can be several types of post-filters 162 that utilize mapped golf hole information. Two exemplary ones explained herein are based on strength of the golf swing (off-green filter) and golfer's known posture at address (in-green filter), see FIG. 20A and FIG. 20B.

The off-green filter in FIG. 20A is a simple yet effective post-filter 162 when the golfer is away from the extended green object 152. Full-swing strokes like drives from the tee object 120 or even partial-swing strokes closer to the green object 124 have relatively strong swing compared to putts or very short chips. The swing strength D_{S} is defined as the maximum of filtered sensor signal during swing gesture. A threshold T_{G} can be set so that the swing strength of the strokes taken inside the extended green object 152 keep below T_{G}. The other way around: The recognition results for strokes having swing strength below T_{G} are rejected outside the extended green object 152.

On the other hand, the in-green filter in FIG. 20B is potentially most effective inside the green object 124 where the golfer's posture is stable, but the detection sensitivity must be kept highest, which can result in greater amount of false recognitions. Meaning that the orientation of golfer's arm O_{S}, on which the detection device 2 is worn, can be assumed to be within predetermined bounding volume B. The orientation O_{S} and the bounding volume B can be presented in Cartesian coordinate system G (X, Y, Z) or in polar coordinate system R (yaw γ, roll φ, pitch θ). When a potential shot is recognized inside the green object 124 it is rejected if the arm orientation Oₐᵣₘ is outside the putt bounding volume Bₚᵤₜₜ and swing strength is below T_{G}, FIG. 20B. The golfer specific nominal posture at address O₀ can be measured for putts and limits of the bounding volume Bₚᵤₜₜ defined in advance instead of using general default limits which can be applied elsewhere in the hole.

Thus in this exemplary case location based configuration parameters according to the invention could be the threshold of impact detection T₁ in the stage 1, the type of stroke target g_{T}(t) applied in the algorithm in the stage 2, the threshold T_{G} for maximum swing strength of putts in the stage 3, the putt bounding volume Bₚᵤₜₜ in the stage 3 or any combination of them. This way the exemplary automatic stroke recognition algorithm presented could be always kept configured for accurate results during the round of golf: The algorithm is sensitive to true strokes yet insensitive to false ones.

Those skilled in the art understand that the mapping based configuration method can be applied also in case of other sensors and recognition algorithms besides what has been described herein; gyroscope, impact sensor, velocity sensor, angular rate sensor, microphone to mention some. Other mapped hole objects besides the tee object 120 and the green object 124 and the distance to pin 125 can be used to trigger specific parameter configuration, e.g. the bunker 122 and rough objects or distance to green 124 border. The actual parameters depend on algorithm used so one should regard the stroke recognition algorithm, detection threshold, type of stroke targets and other parameters mentioned above as an example only.

Some advantageous embodiments according to the invention were described above. The invention is not limited to the embodiments described. The inventional idea can be applied in numerous ways within the scope defined by the claims attached hereto.

What is claimed is:

1. A method for updating hole automatically in a golf tracking system comprising:
Observing change of surface location of golfer based on position and course map data; and
Updating hole to the hole of the most recent surface location.

2. The method of claim 1 wherein the position data is golfer's location or stroke candidate location in the hole map.

3. The method of claim 1 wherein the course map data consists of mapped hole objects and mapped tee, fairway, green, bunker, water hazard, pin and pivot objects of holes.

4. The method of claim 3 wherein the tee objects of hole are presented as a combined tee area object computed using convex hull or non-convex hull algorithms.

5. The method of claim 1 wherein the step of observing change of surface location comprises:
Recording golfer position data update;
Observing golfer has visited the green object of the hole;
Observing golfer has entered a tee object on any hole;
Updating surface location to said tee object.

6. The method of claim 1 wherein the step of observing change of surface location comprises:
Recording stroke candidate position data;
Observing said stroke candidate is inside a mapped object on any hole;
Observing hole number of said mapped object is different to hole number selected by golfer;
Updating surface location to said mapped object.

7. The method of claim 6 wherein the observing step is accomplished for the first recognized stroke of present hole and the mapped object is a tee object;

8. A method for improving accuracy of an automatic golf stroke recognition algorithm comprising:
Configuring parameters of recognition algorithm based on position and course map data;
Detecting set of stroke candidates from recorded sensor data with a configurable stroke recognition algorithm; and
Rejecting false stroke recognitions from said set of stroke candidates with configurable post-filtering algorithm.

9. The method of claim 8 wherein the position data includes golfer's position, ball location in the hole map and distance to mapped object.

10. The method of claim 8 wherein the detecting step is accomplished by using an impact detector or a cross-correlator or both.

11. The method of claim 10 wherein the configurable parameter of the impact detector is detection sensitivity.

12. The method of claim 11 wherein the configuration changes depending on distance to the green object and to the pin object.

13. The method of claim 10 wherein the configurable parameter of the cross-correlator is type of stroke target.

14. The method of claim 13 where in the type of stroke target is full-swing, partial-swing, drive, pitch, chip or putt or combination of them.

15. The method of claim 13 wherein the configuration changes depending on position of played ball in the hole map.

16. The method of claim 8 wherein the post-filtering algorithm is an off-green filtering algorithm comprising the steps of:
Executing filter algorithm when ball lie of stroke candidate is outside the green object and further than pre-defined distance from the pin object; and
Rejecting false stroke recognitions having swing strength below pre-defined threshold.

17. The method of claim 8 wherein the post-filtering algorithm is an in-green filtering algorithm comprising the steps of:
Executing filter algorithm when ball lie of stroke candidate is inside green object and swing strength of said stroke candidate is below pre-defined threshold;
Computing players arm orientation at address position of said stroke candidate; and
Rejecting false stroke recognitions having said arm orientation outside pre-defined bounding volume.

18. The method of claim 8 wherein the post-filtering algorithm consists of one or more post-filtering algorithms.
